(19) United States
(12) Patent Application Publication
(10) Pub. No.: US 2016/0063211 A1
(43) Pub. Date: Mar. 3, 2016

(54) SYSTEMS AND METHODS FOR MODELING MEDICAL CONDITION INFORMATION

(71) Applicant: CHEN TECHNOLOGY, INC., Miami Gardens, FL (US)

(72) Inventor: James J. CHEN, Miami Gardens, FL (US)

(21) Appl. No.: 14/838,087

(22) Filed: Aug. 27, 2015

Related U.S. Application Data
(60) Provisional application No. 62/042,760, filed on Aug. 27, 2014.

(51) Int. Cl. G06F 19/00

(52) U.S. Cl. CPC G06F 19/3437; G06F 19/322; G06F 19/325

(57) ABSTRACT

Methods, systems, and computer-readable media for presenting graphical user interface objects for generating and/or facilitating resource assessments within a healthcare environment are described. In general, a resource assessment may include a determination of performance of a healthcare unit with respect to healthcare information, for instance, the treatment of a chronic condition. Systems described according to some embodiments may include healthcare assessment models configured to provide visual, graphical tools for automatically generating and/or facilitating the generation of medical and/or resource assessments and/or decisions within a healthcare environment. The models may provide healthcare professionals and administrators with increased visibility into all of the medical diagnoses reported on patients, both from internal and external sources, and the overall process from diagnosing conditions to billing.

### CROSS-REFERENCE TO RELATED APPLICATIONS

This application claims priority to U.S. Provisional Application No. 62/042,760, filed Aug. 27, 2014 entitled “Systems and Methods for Modeling Medical Condition Information,” the contents of which are incorporated herein by reference in its entirety.

### BACKGROUND

Healthcare providers generate large amounts of information relating to patients, patient care, and the medical professionals delivering treatment. This information is typically stored in multiple databases and database tables. Accordingly, access to the information is provided through database queries. As such, receiving information about a particular area of interest generally requires the building of complex queries, for example, information pertaining to the diagnosis of medical conditions within a group of healthcare providers. This requires multiple rounds of communication between healthcare professionals and administrators and the technical team supporting the databases. The ultimate result is that the individuals who may use the medical condition diagnosis information to better understand and improve the operations of a healthcare entity do not have efficient, timely access to the information. Thus, they typically use outdated and incomplete information. Accordingly, a healthcare entity would benefit from a system capable of providing healthcare professionals and administrators with dynamic, real-time interfaces configured to present healthcare information of interest without having to build complex database queries.

### BRIEF DESCRIPTION OF THE DRAWINGS

The above and other objects of the present invention will become more readily apparent from the following detailed description considered in concert with the accompanying drawings.

FIG. 1 depicts an illustrative medical conditions management system according to a first embodiment.

FIG. 2 depicts an illustrative medical conditions management system according to a second embodiment.

FIG. 3 depicts an illustrative medical condition model according to some embodiments.

FIGS. 4A-C depict an illustrative medical condition model according to some embodiments.

FIG. 5 illustrates various embodiments of a computing device for implementing the various methods and processes described herein.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a healthcare environment resource assessment system may include a client computing device comprising a processor and a non-transitory, computer-readable storage medium in operable communication with the processor. The computer-readable storage medium may include one or more programming instructions that, when executed, cause the processor to receive healthcare information from a server computing device in communication with the client computing device, cause a presentation of a plurality of navigation objects on a display device in operable communication with the processor, the navigation objects being configured to select the healthcare information, and cause a presentation of a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

In an embodiment, a computer-implemented method for resource assessment within a healthcare environment may include, by a processor of a client computing device, receiving healthcare information from a server computing device in communication with the client computing device, causing a presentation of a plurality of navigation objects on a display device in operable communication with the processor, the navigation objects being configured to select the healthcare information, and causing a presentation of a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

In an embodiment, a computer-readable storage medium having computer-readable program code configured for resource assessment within a healthcare environment may include computer-readable program code configured to receive healthcare information from a server computing device in communication with the client computing device, computer-readable program code configured to present a plurality of navigation objects on a display device in operable communication with the processor, the navigation objects being configured to select the healthcare information, and computer-readable program code configured to present a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

### DETAILED DESCRIPTION

The described technology generally relates to systems, methods, and non-transitory computer-readable media for modeling medical conditions associated with a plurality of patients. In particular, some embodiments provide a medical conditions management system (the “system”) configured to analyze, examine, search, investigate, consider, evaluate, and/or otherwise process medical condition information and/or healthcare information associated with various medical conditions, including chronic conditions, in order to generate and/or facilitate resource assessments. Non-limiting examples of medical conditions may include vascular disease, congestive heart failure, polyneuropathy, renal failure, diabetes, chronic obstructive pulmonary disease, mental health conditions (e.g., bipolar disorder, depression, etc.), drug and alcohol dependence, malnutrition, ulcers, pancreatic disease, cirrhosis, spinal cord injury, head injury, Parkinson's disease, Huntington's disease, cancer, vascular disease, paraplegia, amputation, infection, coma, muscular dystrophy, pneumonia, emphysema, septicemia, and any other medical conditions monitored or treated by a healthcare facility. In some embodiments, the system may be configured to extract data associated with various medical conditions and to present the data as meaningful information to facilitate and/or generate, for example, comprehensive, accurate, and efficient administrative assessments and/or decision-making by a healthcare facility, insurance provider, or the like.

In some embodiments, the models (“healthcare assessment models”) described according to some embodiments may be used to provide visual and/or graphical tools for automatically generating and/or facilitating the generation of medical and/or resource assessments and/or decisions within a healthcare environment. For example, the resource assessments and/or decision making may include evaluating the composition of chronic condition treatment and/or treatment outcomes for a physician's panel to compare with other physicians within a healthcare unit, such as a group of healthcare professionals (e.g., a panel of physicians), a healthcare entity, a medical team, a region, a municipality, a state, a healthcare field, a time period, and/or the like. In some embodiments, such assessments and/or decision making may include and/or may operate in conjunction with processes involving scheduling patients, physician workload, focusing clinical initiatives, or other healthcare resources and/or processes. In some embodiments, a resource assessment may include assessments, quantifications, or other determinations relating to the performance of a healthcare unit in relation to healthcare information, such as treatment of a chronic condition, billing, and/or other processes. The resource assessments may include quantification and/or comparisons of healthcare unit performance, for instance, with respect to treatment outcomes, repeat patient visits, billing, insurance coverage, or the like.

In some embodiments, the system may generate data models configured to populate information that can be used to evaluate the composition of chronic conditions for a physician's panel and compare it to others in a practice. The presentation of such information through the models may be used for, among other things, providing resource assessments and/or graphical images for determining physician workload and managing clinical initiatives. As described herein, the models may provide healthcare professionals and administrators with increased visibility into all of the medical diagnoses reported on patients, both from internal and external sources, and the overall process from diagnosing conditions to billing. In addition, the models may compare incidences of certain conditions, or categories of conditions, across healthcare entities and markets. In this manner, the models may be used to provide graphical images to users for determining healthcare entity efficiency and case management studies. For instance, the models may be used to graphically allow a healthcare professional to determine whether a certain healthcare entity (e.g., a primary care physician (PCP)) is under- or over-diagnosing certain conditions and/or to automatically generate assessments relating thereto.

Existing technology generally provides medical information based on a database structure in which objects have a value and file location relationship, thus providing expected results, at retrieval time, by querying a number of parameters. Models configured according to some embodiments described herein may provide an end user with the ability to produce data without the need to use multiple parameters. For example, interfaces (e.g., digital “charts”) may provide one click data navigation and/or selection that can be sufficiently powerful to start generating information, for example, on the patient-physician and assigned market(s) relationship. In some embodiments, the system may maintain the selected option(s) active as the end user continues to choose other objects, if needed, so that the final output is specifically associated with the expected results. In some embodiments, the information may be presented simultaneously via a plurality of display devices to multiple internal entities, such as a board of directors, administrators, medical directors, technical teams, analysts, or the like. The internal entities may use the presented information to assess the patient treatment data, for example, with a goal to improve the level of service provided to patients by providing sound recommendations on overlooked diagnoses based on norms of a patient population. In some embodiments, the result of the data produced by the models may be used to evaluate patient encounters and evaluate a business impact.

As described in more detail below, the system may be configured to allow immediate access to patient encounter information without exposing end users to the complex compilation of text data or charts. The dynamics of data navigation and progressive conversion may occur in the background, seamless to the end users, allowing them more time to evaluate the presented information. Healthcare professionals at a particular healthcare entity (e.g., a hospital) may review a full course of patient encounters and obtain an awareness of the distribution of clinical conditions, which may assist in identifying areas for improvement in diagnoses and clinical focus to guide various clinical initiatives. For instance, once the data points are fully analyzed, the corresponding teams responsible for managing the physicians may determine modifications in clinical initiatives or improvements in billing processes that would benefit the healthcare entity.

The system provides multiple technological advances over traditional paper-based systems, conventional computer-based systems, and/or hybrid paper- and computer-based systems. Paper-based systems, such as conventional medical charting and medical administration documentation techniques, are not capable of providing a user interface for interactive access to healthcare information, processes, or the like. In particular, traditional paper-based healthcare information systems rely on physical patient files with collections of charts and past medical records. Such patient files are not capable of being automatically or dynamically updated, correlated, and/or linked, and do not provide access to a patient's complete medical history. Accordingly, healthcare professionals are not capable of accessing all of the information necessary to efficiently make accurate and reliable assessments regarding care provided by a healthcare professional and/or at a healthcare entity using such paper-based medical files. In addition, healthcare professionals are not able to efficiently access the information that they need, because obtaining information requires physically searching through multiple documents, charts, and other files.

Conventional computer-based systems provide some improvements, but suffer from many of the same deficiencies as paper-based systems, except that the healthcare provider or healthcare entity administrator interacts with a computer screen instead of a paper file. Although a computer is able to locate and process information much faster, such conventional computer-based systems are not configured to present the information in an efficient, meaningful way that assists healthcare professionals and/or administrators with making faster and more accurate decisions for patient care. Conventional computer-based systems require healthcare professionals to manually page through volumes of information to locate the data required to make an assessment. In addition, conventional computer-based systems do not provide a single interface for presenting relevant information from different screens, or the like, so that a healthcare professional or administrator has the relevant information in a single area, for example, for comparative purposes. Conventional computer-based systems are able to present information faster; however, they are not able to present meaningful information that assists healthcare professionals or an administrator with efficiently sharing information and making quick and accurate assessments or decisions.

In contrast, the methods and systems described according to some embodiments reduce the resources, time, and cognitive effort required for healthcare professionals and administrators to access, quantify, and assess healthcare information. For instance, the system may be configured to transform healthcare information into objects, object values, and/or characteristics of objects displayed on a graphical user interface. In this manner, information may be transformed into graphical interface objects and/or characteristics thereof that may be used to allow medical professionals or administrators to more efficiently, effectively, and accurately provide patient care, perform billing processes, and quantify and/or assess patient-physician relationships, market dynamics, patient encounters, and business impact, than is possible using conventional techniques and processes.

The system may present novel software tools and user interfaces that solve technical problems relating to quantifying and/or assessing patient medical care, such as evaluating the composition of chronic conditions treated by one or more healthcare professionals and/or at one or more healthcare entities and comparing this composition to other practices and/or professionals to determine potential areas of over- or under-diagnosis and allow targeted education or patient panel analysis based on results. The novel software tools may also allow a healthcare entity administrator to efficiently and accurately follow diagnoses through patient visits, billing, and acceptance by a health or insurance plan, for instance, to ensure the integrity of treatment and/or billing processes. For instance, in one non-limiting embodiment, the system may be used by a healthcare entity Board of Directors, Medical Directors, and/or other teams to review a full course of patient encounters and gain an awareness of the distribution of clinical conditions to efficiently and effectively identify areas for improvement in diagnoses and/or to measure the status or progress of clinical initiatives.

Healthcare information may generally include medical information associated with a healthcare entity, such as a patient, a healthcare professional, a healthcare facility, or the like. Non-limiting examples of healthcare information may include, without limitation, age, gender, weight, height, medications, surgeries and other medical procedures (for example, diagnostic tests, diagnostic imaging tests, or the like), occupation, past and current medical conditions, family history, patient description of health condition, healthcare professional description of health condition, symptoms, medical survey information, medical claims, medical scores (for example, Centers for Medicare and Medicaid (CMS) hierarchical condition categories (HCC) scores), healthcare professional information, primary care physician/provider (PCP), health insurance information, health care facility information, or the like.

Medical condition information may generally include information associated with a medical condition, including categories, codes, or other designations associated with a medical condition. The medical condition information may include CMS and HCC. Although HCC is used in examples described herein, embodiments are not so limited, as the system may use various other types of coding, categorizing systems, and medical condition information.

In some embodiments, the system may be configured to analyze various medical information databases according to a set of rules and to identify and extract patients associated with certain medical condition information. For example, the system may be configured to present a user with all patients flagged with one or more medical diagnosis codes. Patient information associated with the extracted patients may be presented to a user in various forms. For instance, a patient conditions or problems list (the “problems list”) may provide a user with a graphical representation of various information associated with the extracted patients. In another instance a “details” interface may be provided for presenting various detailed information associated with a patient, a medical condition, a healthcare facility, or the like.

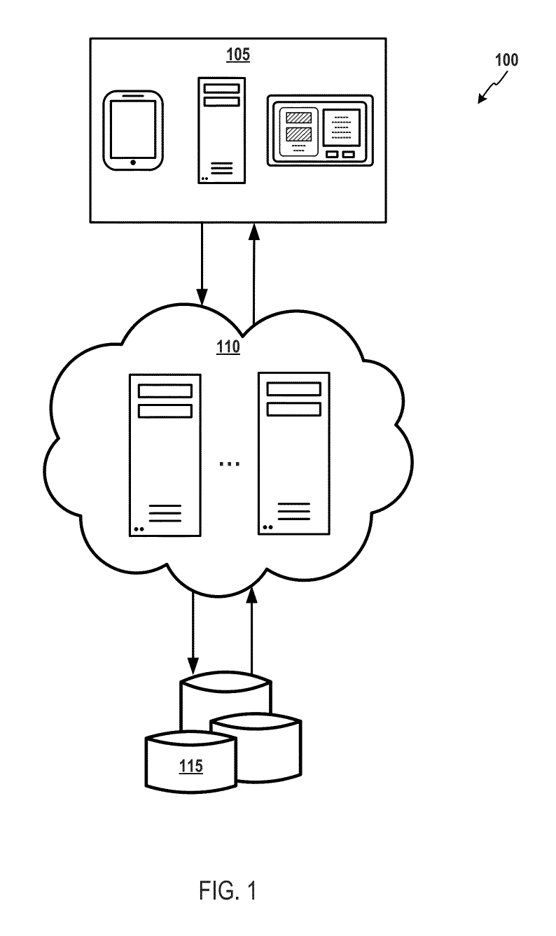

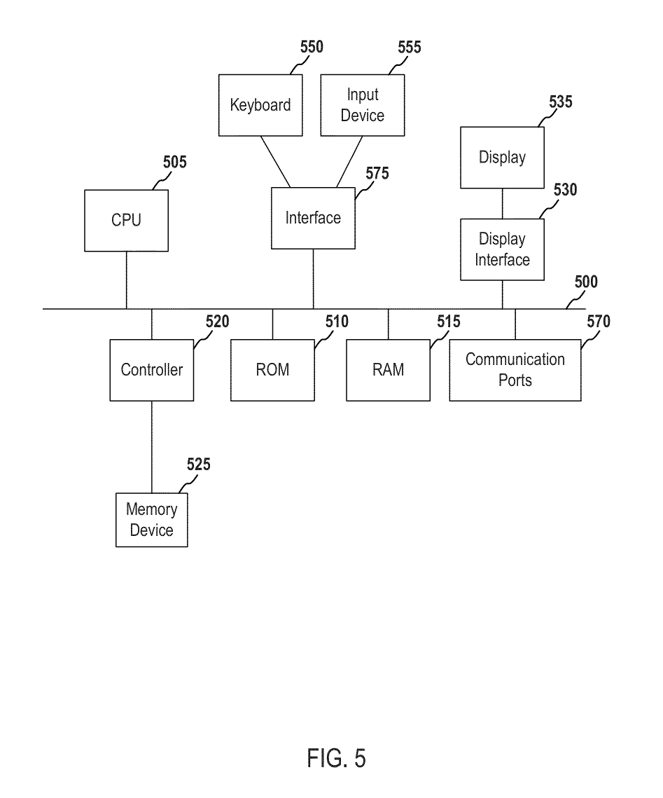

FIG. 1 depicts an illustrative system according to a first embodiment. As shown in FIG. 1, the system 100 may include one or more server logic devices 110, which may generally include a processor, a non-transitory memory or other storage device for housing programming instructions, data or information regarding one or more applications, and other hardware, including, for example, the central processing unit (CPU) 505, read only memory (ROM) 510, random access memory (RAM) 515, communication ports 540, controller 520, and/or memory device 525 depicted in FIG. 5 and described below in reference thereto.

In some embodiments, the programming instructions may include a medical condition management application (the “management application”) configured to, among other things, analyze medical condition information and/or healthcare information from various sources using medical condition analysis rules (“rules”) and generate graphical interfaces for presenting medical condition models (“models” or “fingerprints”). The server logic devices 110 may be in operable communication with client logic devices 105, including, but not limited to, server computing devices, personal computers (PCs), kiosk computing devices, mobile computing devices, laptop computers, smartphones, personal digital assistants (PDAs), medical equipment, tablet computing devices, or any other logic and/or computing devices now known or developed in the future.

In some embodiments, the management application may be accessible through various platforms, such as a client application, a web-based application, over the Internet, and/or a mobile application (for example, a “mobile app” or “app”). According to some embodiments, the management application may be configured to operate on each client logic device 105 and/or to operate on a server computing device accessible to logic devices over a network, such as the Internet. All or some of the files, data and/or processes (for example, medical condition information, patient information, or the like) used for generating medical condition models may be stored locally on each client logic device 105 and/or stored in a central location and accessible over a network. In some embodiments, the management application may use and/or include the Open System Interconnection (OSI) model networking framework to implement the processes, methods, and functions described according to some embodiments.

In some embodiments, one or more data stores 115 may be accessible by the client logic devices 105 and/or server logic devices 110. The data stores 115 may include medical condition information, patient information, rules, and/or models, including third-party data sources thereof. In some embodiments, at least a portion of the data stores 115 may include information associated with a healthcare information system, including, without limitation, healthcare information and management systems (HIMS), electronic medical record (EMR) systems, electronic health record (EHR) systems, radiology information systems (RIS), picture archiving and communications system (PACS), Medicaid Management Information Systems (MMIS), health insurance provider systems, and/or the like. In some embodiments, the data stores 115 may include information obtained from multiple healthcare facilities, healthcare providers, and/or health insurance providers. In some embodiments, at least a portion of the data stores 115 may include a third-party data source, including, without limitation a government healthcare information system (for example, CMS), a medical library, a third-party medical database, a health insurance provider information system, and/or the like. In some embodiments, the information in the data stores 115 may include lifetime clinical records (LCRs), which may include a component of a digital electronic health record (for instance, EMR, EHR, or the like) system. An LCR may allow a health care professional to look at a patient's long-term medical history, including all of the results of the different kinds of procedures, tests, diagnoses, or the like, that a patient has undergone during his/her lifetime.

Although the one or more data stores 115 are depicted as being separate from the logic devices 105, 110, embodiments are not so limited. As all or some of the one or more data stores 115 may be stored in one or more of the logic devices 105, 110.

As described in more detail below, the management application may access information and/or processes stored in the data stores 115 to generate graphical user interface (GUI) objects (or “graphical objects') for, among other things, presenting medical condition information and/or models to a user. A healthcare professional may initiate the generation of a model from a client logic device 105, and the management application may generate a graphical user interface object of a model for presentation on a display component of the client logic device.

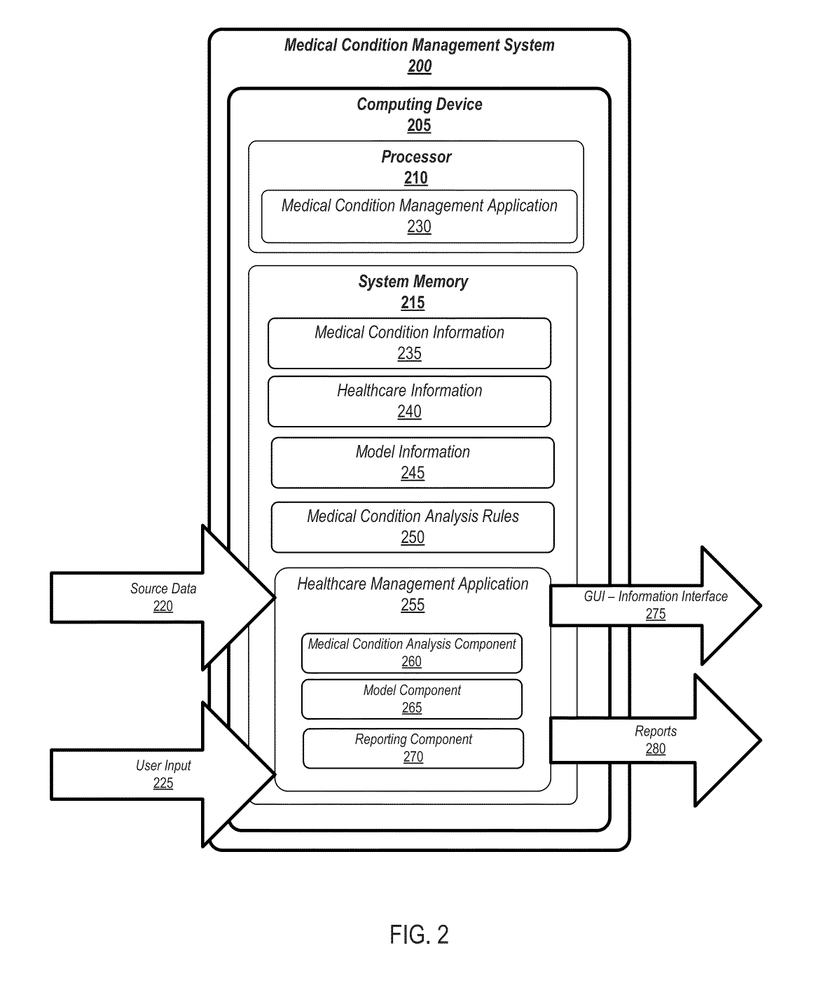

FIG. 2 depicts an illustrative healthcare management system according to a second embodiment. As shown in FIG. 2, a healthcare management system (the “management system”) 200 may include a computing device 205 having a processor 210 and system memory 215. The computing device 205 may include any type of computing device, such as the client logic device 105 and server logic devices 110 described in reference to FIG. 1. The processor 210 may be configured to execute a healthcare management application (the “management application”) 255. The management application 255 may be configured to receive source data 220 and/or user input 225, for instance, through the processor 210 and/or as stored or cached as medical condition information 235, healthcare information 240, model information 245, and/or medical condition analysis rules (“analysis rules”) 250 in the system memory 215.

The source information 220 may include information from any data source accessible by the system 200, including, without limitation a healthcare information and management systems (HIMS), electronic medical record (EMR) systems, radiology information systems (RIS), picture archiving and communications system (PACS), Medicaid Management Information Systems (MMIS), health insurance provider systems, and/or any other type of data store having healthcare information, a health information library and/or cloud, a third-party database, or the like.

In some embodiments, the source information 220 may include any information associated with a patient, a medical provider, a healthcare facility, a medical procedure, a health insurer, a medical claim system (for example, Medicare, Medicaid, CMS-HCC, health insurance medical claim systems, or the like), or any other source of healthcare information. Non-limiting examples of source information 220 may include any information associated with the physical and/or mental condition of a patient, medical condition, symptoms, medical history, medications, family history, diseases, illnesses, conditions, surgeries, medical procedures, medical diagnostic tests, vital signs, lab results, associated healthcare providers, demographic information, allergies, responses to treatment, responses to medication, health insurance information, medical claims, medical costs, medical professional information, PCP information, healthcare facility information, payment information, billing information, or the like. The source information 220 may be processed by the management application 255 and stored in the system memory 215 as medical condition information 235. Accordingly, the source information 220 may generally include any information capable of being used to generate medical condition information 235, healthcare information 240, and/or analysis rules 250 according to some embodiments.

The management application 230 may include various modules, programs, applications, routines, functions, processes, or the like (“components”) to perform functions according to some embodiments described herein. In some embodiments, the management application 255 may include a medical condition analysis component 260, a model component 265 and a reporting component 270.

In some embodiments, the components 255-265 may be configured to access the source data 220, medical condition information 235, healthcare information 240, and analysis rules 250 according to some embodiments described herein. The medical condition analysis component (“analysis component”) 255 may be configured to access the medical condition information according to the analysis rules 250. For instance, the analysis rules 245 may specify various rules, filters, algorithms, processes, or the like for accessing and/or querying the medical condition information 235. The analysis rules 250 may be specified by a user and modified dynamically based on, for instance, user input 225 and/or the medical condition information. For instance, the analysis rules 250 may add/remove a query filter and/or access a particular data table based on the query results when accessing the medical condition information 235 and/or healthcare information 240. Processing of the medical condition information and/or the healthcare information 240 using the analysis rules 250 may generate model information 250.

The model component 260 may be configured to generate graphical user interface elements in the form of models based on the model information 245, alone or in combination with the healthcare information 240. The model component 260 may be configured to present the model to a user via a graphical user interface 275. In some embodiments, the graphical user interface 275 may include a window, screen, or other graphical user interface presented on a display of a logic device. The graphical user interface 275 may be configured to graphically represent the model. The reporting component 270 may be configured to generate various reports 280 presenting the model and/or information associated with the model.

The management application, such as through the various components described in reference to FIG. 2 above, may obtain information from various databases. The information may be organized into various modules. Non-limiting examples of modules may include a Main module, a PCP module, and a Medicare Risk Adjustment (MRA, eMRA or vMRA) module. Each of the modules may be associated with corresponding data navigation objects implemented through various graphical user interface elements, such as list boxes. In some embodiments, a user may access or operate a module by selecting one or more corresponding data navigation objects depending on the kind of patient data needed to make specific assessments, business adjustments, quantifications, or the like.

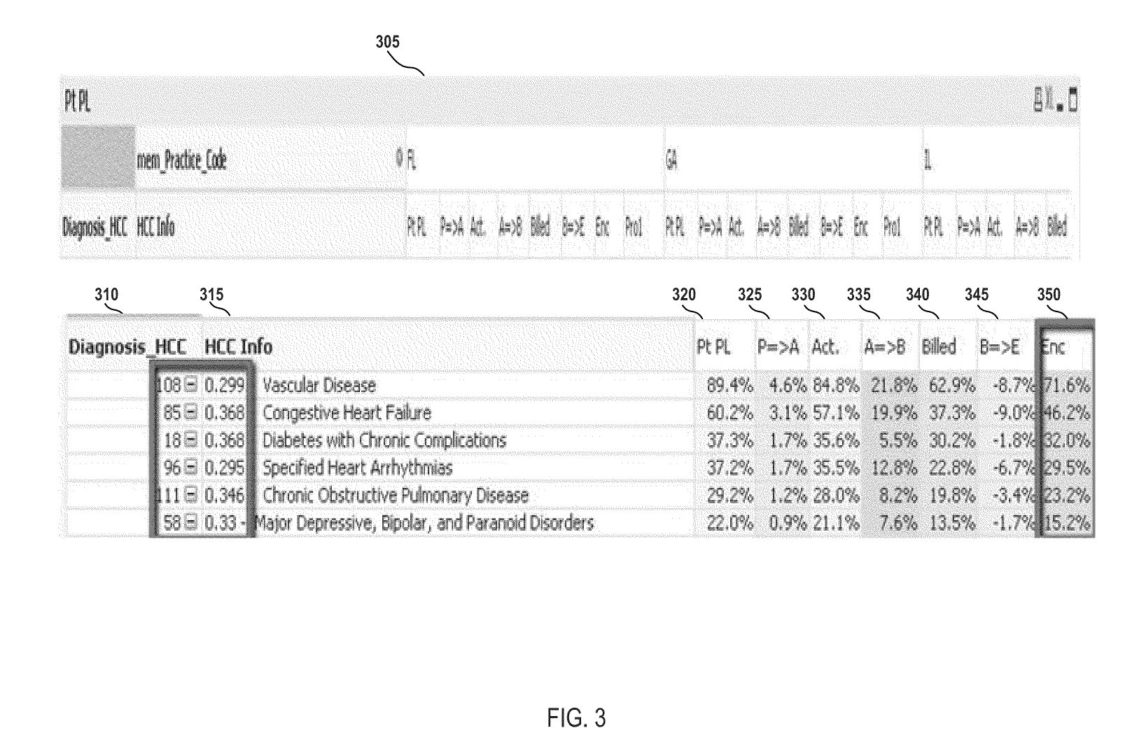

As shown in FIG. 3, the model may include a problem list chart object 305 graphical user interface element. In some embodiments, a problem list chart object 305 may incorporate various components that allow the correct computation of the medical condition information, such as HCC numeric values. A diagnosis object 310 may be configured to display medical condition information, such as a medical condition code, number, category, descriptor, or other identifier (e.g., an HCC category) that a patient has been diagnosed with. A medical conditions information object 315 may be configured to display patient medical condition categories and corresponding diagnosis codes. The problem list chart object 305 may also include a patient problem list object 320 and may be configured to show the percentage of patients, per market, that have been diagnosed with one or more medical conditions (i.e., HCC categories). In some embodiments, the information may be organized in descending order where the most frequent medical conditions (i.e., HCC categories) and higher percentage values are at the top. A problem-to-active object 325 graphical user interface element may be configured to show the values gap that is obtained by subtracting the patient problem list object 320 values from the act object 330 values. For instance, 89.4% (patient problem list object 320 value) minus 84.8% (act object 330 value) yields a 4.6% gap (problem-to-active object 325 value), which represents the percentage of patients with the corresponding condition who have not visited a particular healthcare facility or provider to have the conditions addressed. The act object 330 presents values representing a total percentage of patients with a corresponding condition that have visited a particular healthcare facility or provider. The act object 330 values may be obtained by subtracting the problem-to-active object 325 values from the patient problem list object 320 values.

The active-to-bill object 335 graphical user interface element may present values representing the percentage of patients with a specified condition that have visited a particular healthcare facility or provider but not had the condition billed. In some embodiments, this value may be obtained by subtracting the billed object 340 values from the act object 330 values. In some embodiments, the active-to-bill object 335 values may facilitate the identification of delays or processing problems with the billing or billing system of a particular healthcare facility or provider. The billed object 340 presents values showing the total percentage of patients with a specified condition who have visited a particular healthcare facility or provider and have had those conditions billed, for example, through an internal billing system.

A medical billing deficiency object 345 graphical user interface element presents values representing the number of patients that have been diagnosed with a specific medical condition (e.g., HCC category) and have been billed, but who are not listed in a medical billing system of a particular healthcare facility or provider. The percentage may be obtained by subtracting the medical billing object 350 values from the billed object 340 values. In some embodiments, the medical billing deficiency object 345 values may facilitate the identification of instances in which the billing of a particular healthcare facility or provider is not being accepted by a health plan, insurance plan, or the like. The medical billing object 350 may present values that represent the percentage of patients that have been diagnosed with one or more specific medical conditions (e.g., HCC categories) and have had those medical conditions addressed, billed, and accepted by medical billing. In some embodiments, problem list chart 305 may also include an object configured to present information associated with the percentage of patients who have had a diagnosis accepted within an insurance provider system (e.g., a Humana® Pro STAR system).

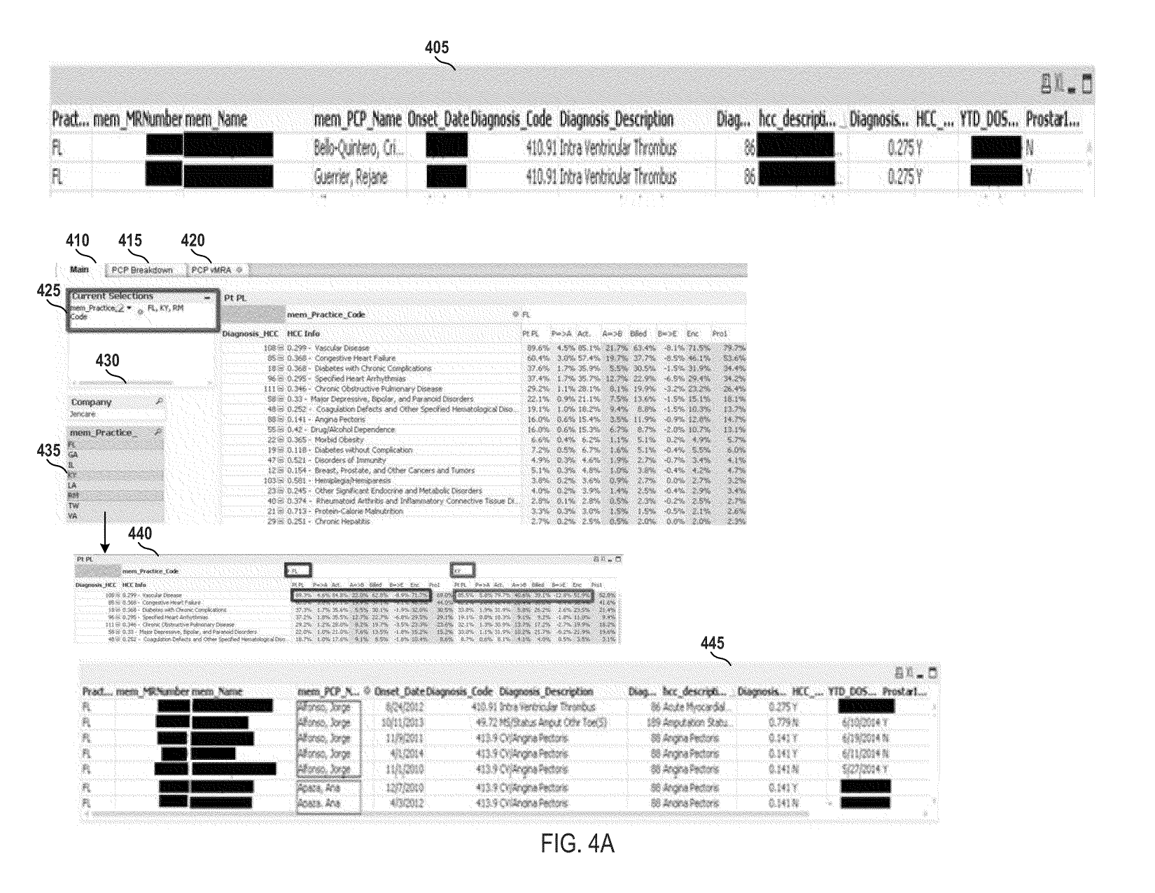

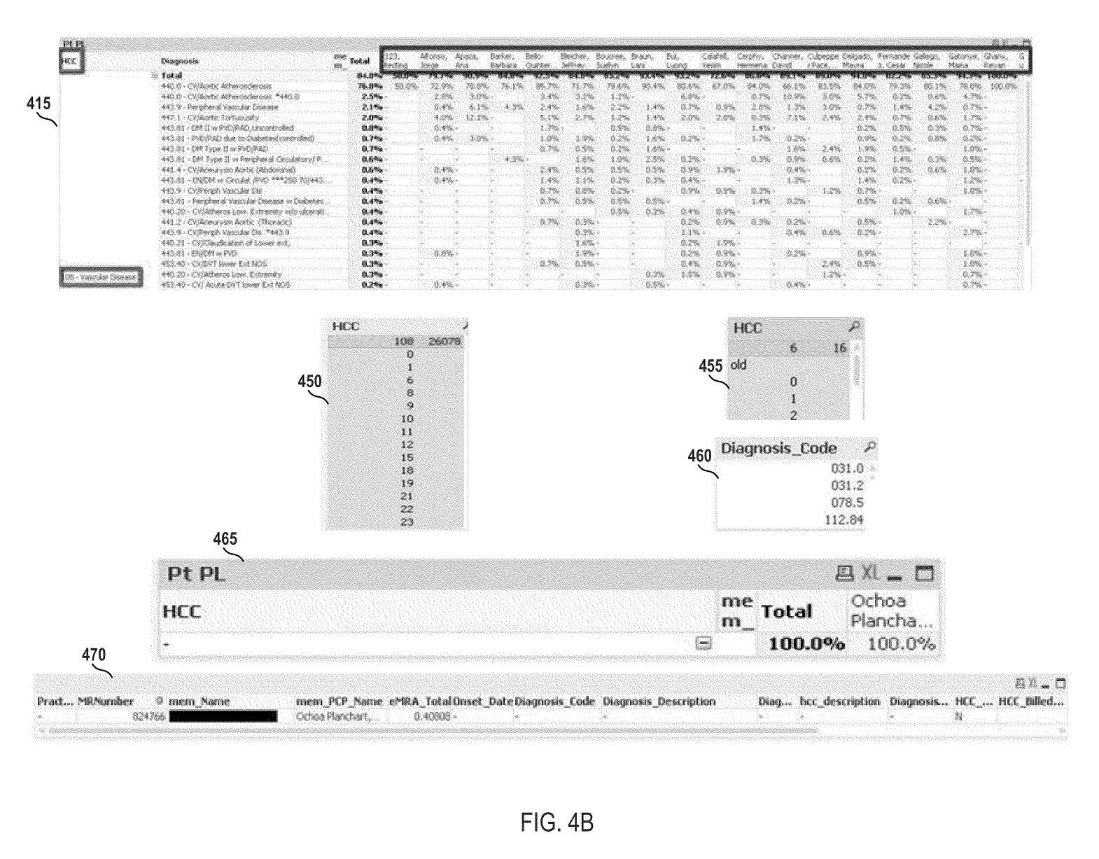

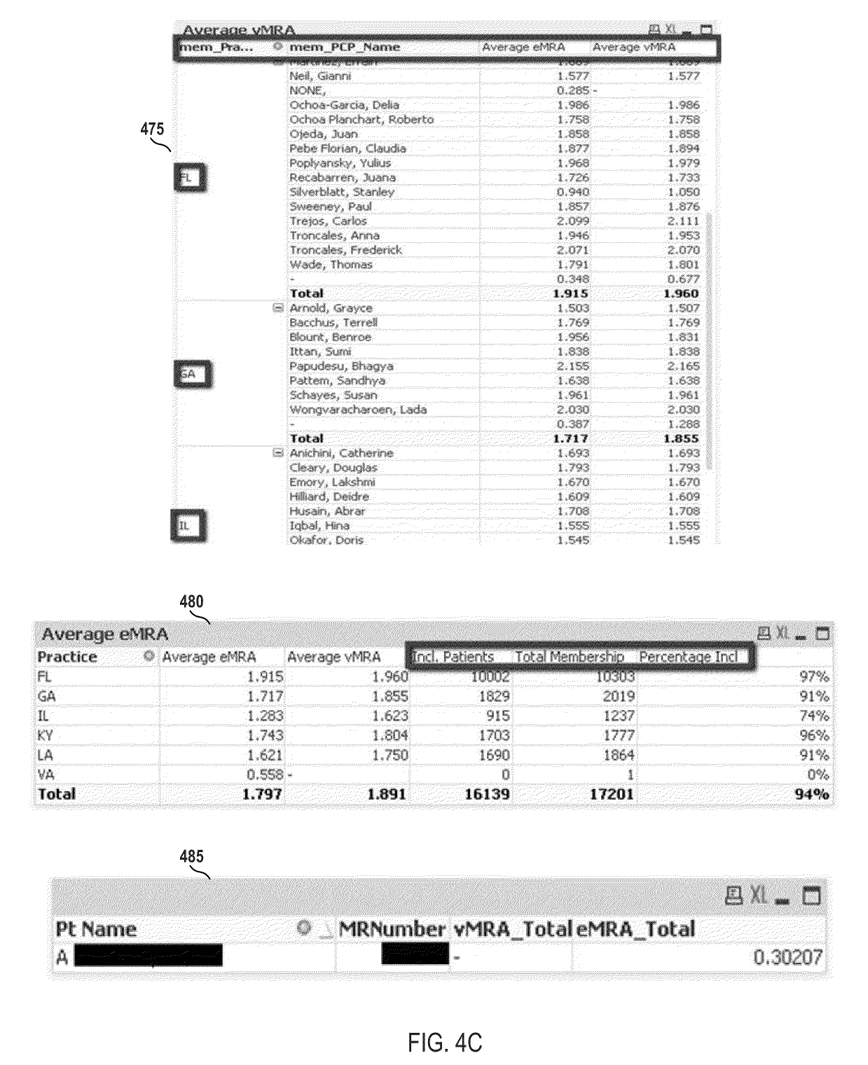

As shown in FIG. 4A, the model may include a details chart 405 graphical user interface element. In some embodiments, the details chart 405 may be configured to present information based on various data navigation selections. In some embodiments, the information, graphics, and other objects presented through the details chart 405 and/or the problem list chart 305 may be dynamically generated and/or updated in real time or substantially real time based on changes to the information and/or user selection of data navigation objects. In some embodiments, the presented information may include patient information. In some embodiments, the presented information may include medical condition information and patient information. The details chart 405 may include various tabs for the presentation of information and objects, including, without limitation, a main tab 410, a PCP breakdown tab 415, and a PCP vMRA tab 420.

In some embodiments, the main tab 410 may include a current selections data navigation object 425 graphical user interface element may be configured to operate as a “storehouse” to reflect patient data that may be populated as a user selects from available options described according to some embodiments. A company data navigation object 430 graphical user interface element may be configured to select a company, for instance, where information is stored. In some embodiments, patient information and/or the presentation thereof may shift according to the company selected via the company data navigation object 430. A market practice data navigation object 435 graphical user interface element may provide for the selection of various practices by state codes for where a particular healthcare provider has practices. For example, the market practice data navigation object 435 may allow a user to select healthcare provider practices by various designations, including, without limitation, state, region, market, practice type, or the like. For instance, the market practice data navigation output 440 may present healthcare practices in states selected by the user.

Year-to-date (YTD) and date-of-service (DOS) data navigation objects (not shown) may allow a user to select one or more dates to show the YTD and/or DOS when a patient was treated by a particular healthcare provider. In some embodiments, selecting date values from YTD and DOS data navigation objects may populate the details chart 405 with information associated with all of the choices that have been previously selected from data navigation objects described according to some embodiments. A medical condition billed data navigation object (not shown) may allow a user to navigate through or select the information presented in the model through the details chart 405 based on whether the medical condition information (e.g., HCC code) has been billed or not. An MRA adjustment data navigation object (not shown) may allow a user to navigate through or select the information presented in the model through the details chart 405 based on whether an MRA or other adjustment has been made to or is associated with the patient information. A healthcare provider name data navigation object (not shown) may allow a user to navigate through or select information based on a name of a particular healthcare provider. In some embodiments, the selection options for the healthcare provider name data navigation object (e.g., as presented in a drop-down list) may be filtered based on a previous selection, such as the market practice data navigation object 435. For instance, the healthcare provider name data navigation may only present names of practices located within a selected region or state. An insurance carrier data navigation object may allow for the selection of one or more insurance carriers associated with a healthcare entity, such as insurance carriers having a contract with the healthcare entity. In some embodiments, selection of an insurance carrier may provide information for markets (e.g., states, healthcare facilities, geographic regions, cities, market segments, etc.) where the insurance carrier has a relationship with the healthcare entity.

A medical professional name data navigation object (not shown) may allow a user to navigate through or select the presented model information based on the name of a selected medical professional, such as a physician. In some embodiments, the selection options for the medical professional name data navigation object may be navigated through or selected based on a previous selection, such as the market practice navigation object 435 and/or the healthcare provider name navigation object. In some embodiments, the resulting medical professional name output 445 of the medical professional name navigation object may be configured to show the relationship between medical condition categories (e.g., HCC categories), diagnosis descriptions, selected patients, and or selected patients-PCP relationships. In some embodiments, the medical professional name navigation object may allow for the selection of multiple physicians, for example, to allow for a comparative analysis of information associated with each selected physician.

Referring now to FIG. 4B, a detailed view of the PCP breakdown tab 415 is depicted. In some embodiments, the PCP breakdown tab 415 may inherit navigation objects and other functionalities from the main tab 410. However, the corresponding information presented on the problem list chart 305 may reflect a list of physicians, medical condition categories (e.g., HCC categories), and corresponding diagnosis descriptions identified with a particular patient. The information presented in the PCP breakdown tab 415 may be dynamically generated based on the selection of a navigation object configured according to some embodiments. For instance, the PCP breakdown tab 415 as depicted in FIG. 4B shows an HCC navigation object and a 108-Vascular Disease HCC code. The PCP breakdown tab 415 may indicate that 0.4% of all of Dr. Alfonso Jorge's patients have been diagnosed with 443.81—DM II (diabetes mellitus type 2) with PVD/PAD, uncontrolled . In some embodiments, the management application may be configured to compute the percentage values for all the diagnoses within a selected code for all participating physicians, such as the 108 code depicted in the PCP breakdown tab 415 in FIG. 4B.

A medical conditions category navigation object 450 may be configured to store and maintain medical condition categories, for instance, HCC codes. In some embodiments, selection of a medical condition category may populate the total number of patients, per correlated code, and present the percentage of patients broke down by PCP in the problem list chart 305 and/or the details chart 405. A diagnosis code navigation object 455 may be dynamically updated based on a selection through the medical conditions category navigation object 450 to populate the correct diagnosis codes 460, for instance, to reflect HCC diagnosis values. A count distinct filter object (not shown) may be configured to reflect the population of patients per practice code. A medical record number (MRN) filter object (not shown) may be configured to display a patient medical record number that may be used, for example, to search for a particular patient without the need to use other navigation objects as shown in the problems list chart output 465 and the details chart output 470.

Referring now to FIG. 4C, the PCP vMRA tab 420 may be configured to provide information presented in an average vMRA chart 475, an average eMRA chart 480, and/or a patient detail chart 485. In some embodiments, the eMRA chart 480 may be configured as an internal (i.e., internal to a healthcare entity) chart graphical object extracted from an internal healthcare information system (e.g., internal EMR system) problem list in the problem list chart 305. In some embodiments, vMRA may be configured to indicate, among other things, conditions present during a patient visit within a particular time period, such as within the past six months. The value of vMRA may be lower for patients who have not visited their physician (or other healthcare professional) within the particular time period, for example, to address a particular condition. Accordingly, in some embodiments, to accomplish average computations, the management application may be configured to provide the average vMRA chart 475, an average eMRA chart 480, and/or a patient detail chart 485 in a predetermined set of columns.

As shown in FIG. 4C, the average vMRA chart 475 may include four main columns to show a member practice broken down by market, PCPs associated with patients, individual PCP average eMRA, and average vMRA. In this manner, a user may be presented with a graphical user interface with sufficient flexibility to navigate and select particular market(s). The average eMRA chart 480 may be configured to populate the average data per selected practice. In some embodiments, the average eMRA chart 480 may present the data in terms of the number of corresponding patients, increase in membership, and/or various percentage calculations based on the data. The patient detail chart 485 may be configured to list vMRA and/or eMRA calculations for each patient. The patient detail chart 485 interface may be configured to provide for a selection of a patient and the association of the results with corresponding fields, such as a practice code, designated PCP(s), medical condition information (e.g., HCC codes and subsequent HCC-related information).

In some embodiments, the model may be configured such that the navigation object and selections thereof may be automated and consolidated, such that all designated data receivers (e.g., healthcare entities, healthcare providers, client logic devices, etc.) may obtain a report without having to manually configure the report. However, users may specify the navigation object to generate their own specific reports according to some embodiments described herein.

FIG. 5 depicts a block diagram of exemplary internal hardware that may be used to contain or implement the various computer processes and systems as discussed above. A bus 500 serves as the main information highway interconnecting the other illustrated components of the hardware. CPU 505 is the central processing unit of the system, performing calculations and logic operations required to execute a program. CPU 505 is an exemplary processing device, computing device or processor as such terms are used within this disclosure. Read only memory (ROM) 530 and random access memory (RAM) 535 constitute exemplary memory devices.

A controller 520 interfaces with one or more optional memory devices 525 to the system bus 500. These memory devices 525 may include, for example, an external or internal DVD drive, a CD ROM drive, a hard drive, flash memory, a USB drive or the like. As indicated previously, these various drives and controllers are optional devices. Additionally, the memory devices 525 may be configured to include individual files for storing any software modules or instructions, auxiliary data, common files for storing groups of results or auxiliary, or one or more databases for storing the result information, auxiliary data, and related information as discussed above. For example, the memory devices 525 may be configured to store data, such as the medical condition information 235, healthcare information 240, model information 245, medical condition analysis rules 250, and/or data contained in the data stores 115.

Program instructions, software or interactive modules for performing any of the functional steps associated with the methods and processes as described above may be stored in the ROM 530 and/or the RAM 535. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 530 may permit information from the bus 500 to be displayed on the display 535 in audio, visual, graphic or alphanumeric format. The information may include information related to a current job ticket and associated tasks. Communication with external devices may occur using various communication ports 540. An exemplary communication port 540 may be attached to a communications network, such as the Internet or a local area network.

The hardware may also include an interface 545 which allows for receipt of data from input devices such as a keyboard 550 or other input device 555 such as a mouse, a joystick, a touch screen, a remote control, a pointing device, a video input device and/or an audio input device.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to”). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example), the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “ a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “ a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or^{,} “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein can be readily broken down into a lower third, a middle third, and an upper third. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A healthcare environment resource assessment system comprising:
a client computing device comprising a processor and a non-transitory, computer-readable storage medium in operable communication with the processor, wherein the computer-readable storage medium contains one or more programming instructions that, when executed, cause the processor to:
receive healthcare information from a server computing device in communication with the client computing device,
cause a presentation of a plurality of navigation objects on a display device in operable communication with the processor, the navigation objects being configured to select the healthcare information, and
cause a presentation of a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

2. The system of claim 1, wherein the computer-readable storage medium further contains one or more programming instructions that, when executed, cause the processor to generate the resource assessment and cause a presentation of a resource assessment graphical object displaying the resource assessment.

3. The system of claim 1, wherein the resource assessment comprises an evaluation of chronic conditions treated by a group of healthcare professionals.

4. The system of claim 1, wherein the resource assessment comprises a comparison of chronic condition treatment for a plurality of healthcare units.

5. The system of claim 4, wherein the healthcare units comprise at least one of a group of healthcare professionals and a plurality of healthcare entities.

6. The system of claim 4, wherein the plurality of healthcare units comprise a plurality of healthcare units located in a plurality of regions.

7. The system of claim 1, wherein the medical condition information comprises hierarchical condition categories scores.

8. The system of claim 1, wherein the medical condition information comprises a medical condition code, a medical condition number, a medical condition category, and a medical condition descriptor for a patient diagnosed with a medical condition.

9. The system of claim 1, wherein the problem list chart comprises a patient problem list configured to show a plurality of percentages of patients diagnosed with one or more medical conditions within a healthcare unit.

10. A computer-implemented method for resource assessment within a healthcare environment, the method comprising, by a processor of a client computing device:
receiving healthcare information from a server computing device in communication with the client computing device;
causing a presentation of a plurality of navigation objects on a display device in operable communication with the processor, the navigation objects being configured to select the healthcare information; and
causing a presentation of a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

11. The method of claim 10, further comprising:
generating the resource assessment; and
causing a presentation of a resource assessment graphical object displaying the resource assessment.

12. The method of claim 10, wherein the resource assessment comprises an evaluation of chronic conditions treated by a group of healthcare professionals.

13. The method of claim 10, wherein the resource assessment comprises a comparison of chronic condition treatment for a plurality of healthcare units.

14. The method of claim 13, wherein the healthcare units comprise at least one of a group of healthcare professionals and a plurality of healthcare entities.

15. The method of claim 13, wherein the plurality of healthcare units comprise a plurality of healthcare units located in a plurality of regions.

16. The method of claim 10, wherein the medical condition information comprises hierarchical condition categories scores.

17. The method of claim 10, wherein the medical condition information comprises a medical condition code, a medical condition number, a medical condition category, and a medical condition descriptor for a patient diagnosed with a medical condition.

18. The system of claim 10, wherein the problem list chart comprises a patient problem list configured to show a plurality of percentages of patients diagnosed with one or more medical conditions within a healthcare unit.

19. A computer-readable storage medium having computer-readable program code configured for resource assessment within a healthcare environment, the computer-readable program code comprising:
computer-readable program code configured to receive healthcare information from a server computing device in communication with the client computing device;
computer-readable program code configured to present a plurality of navigation objects on a display device in operable communication with the processor, the navigation objects being configured to select the healthcare information; and
computer-readable program code configured to present a resource assessment model based on a selection state of the plurality of navigation objects on the display device, the resource assessment model comprising a problem list chart configured to determine medical condition information and a details chart for providing selectable access to the medical condition information, the resource assessment model being dynamically generated in real time or substantially real time based on the healthcare information and the selection state of the plurality of navigation objects, wherein the resource assessment model is configured to facilitate a determination of a resource assessment based on the medical condition information.

20. The computer-readable storage medium of claim 19, further comprising:
computer-readable program code configured to generate the resource assessment; and
computer-readable program code configured to present a resource assessment graphical object displaying the resource assessment.
